(19) United States
(12) Patent Application Publication
(10) Pub. No.: US 2012/0176717 A1
(43) Pub. Date: Jul. 12, 2012

(54) CATEGORY 6A SURGE PROTECTOR

(76) Inventors: Matthew ADOMAITIS, Aurora, IL (US); Richard J. URBAN, Prospect Heights, IL (US)

(21) Appl. No.: 13/342,951

(22) Filed: Jan. 3, 2012

Related U.S. Application Data
(60) Provisional application No. 61/430,364, filed on Jan. 6, 2011.

(51) Int. Cl. H02H 3/20

(52) U.S. Cl. 361/111

(57) ABSTRACT

A surge protector for protecting telecommunications related equipment and other associated sensitive electrical components from over-voltage transient occurring on tip/ring conductors of communication lines coupled thereto includes a printed circuit board and surge protection circuits mounted on the printed circuit board. The surge protection circuits are interconnected between incoming tip and ring terminals defining an unprotected side and outgoing tip and ring terminals defining a protected side. Each of the surge protection circuits has a first set of steering diodes, a pair of series-connected voltage clamping devices, and a second set of steering diodes. Input side connector devices are coupled to the respective incoming tip and ring terminals for connecting to incoming telecommunication lines. Output side connector devices are coupled to the respective outgoing tip and ring terminals for connecting to customers' electrical equipment to be protected.

### CROSS-REFERENCE TO RELATED APPLICATION

This application is a non-provisional application which claims the benefits of provisional application Ser. No. 61/430,364 filed on Jan. 6, 2011.

### BACKGROUND OF THE INVENTION

1. Technical Field

The present invention relates generally to surge protection devices for protecting telecommunications related equipment and associated sensitive electrical components from over-voltage transients.

2. Prior Art

As is generally well known to those skilled in the telecommunications industry, modern telecommunications related equipment is susceptible to transient surges such as those caused by lightning strikes and other voltage/current surges occurring on the incoming power lines. During the occurrence of the lightning strikes or the voltage/current surges on the incoming power lines in a power distribution network provided by electric utility companies, the power lines may become crossed-over or applied directly to the incoming telecommunication lines carrying voice signals, data signals and the like to a users' or consumers' equipment. The voice/data signals may be used for transmitting and/or receiving signals to and from various types of customers' electrical or office equipment, such as telephone sets, computers, facsimile machines, photocopiers, alarm devices, modems, or high-speed interface circuit devices (T-1 line, DSL network, Ethernet network, 10/100/1000 Base-T interface, etc.).

Accordingly, there exist various types of surge protector circuits in the prior art for protecting telecommunications related equipment from transient voltage and/or current surges occurring on transmission lines coupled thereto. However, these known surge protector circuits suffer from a number of disadvantages. For example, certain known surge protector circuits have a limitation on the working bandwidth, which is generally in the range of 250 MHz. It would therefore be desirable to provide an improved surge protector for protecting copper wire networks from over-voltage transients while extending the bandwidth to beyond 500 MHz.

The present surge protector includes a plurality of surge protection circuits and has particular applications in being used for protecting telecommunications related equipment and associated sensitive electrical components from over-voltage transients occurring on tip and/or ring conductors of telecommunication or signal lines coupled thereto.

### BRIEF SUMMARY OF THE INVENTION

Various embodiments of the present invention provide a Category 6A surge protector for protecting networks equipment from over-voltage transients while maintaining high bandwidth network connectivity. In one embodiment, the surge protector includes a plurality of identical surge protection circuits. Each of the identical surge protection circuits is connectible between two wires of incoming telecommunication lines carrying voice signals, data signals and the like of a signal distribution network and two wires of a customers' electrical equipment to be protected. Each of the plurality of surge protection circuits includes a first set of steering diodes, voltage clamping devices, and a second set of steering diodes. The steering diodes are high-speed, low capacitance diodes to provide low capacitance/low crosstalk in addition to low attenuation and low return loss.

In this manner, the surge protector of the present invention is capable of meeting the transmission performance requirements described in the TIA (Telecommunication Industry Association) Standard, TIA-568-B.2-10. The surge protector of the present invention protects against over-voltage transients and at the same time allows for a high data bit rate.

In an embodiment, the surge protector network protects copper wire signal networks from over-voltage transients, while maintaining high bandwidth network connectivity. This surge protector protects against surge levels as described in UL 497, installed in accordance with Article 800 of the National Electric Code (NEC). The purpose of this surge protector is to help reduce the risk of fire, electrical shock, damage to equipment or injury as deployed to high-speed data systems.

It is therefore an advantage of the disclosed embodiments to provide a surge protector for protecting copper networks which provides over-voltage protection for four pairs of telecommunication lines.

Another advantage of the present invention is to provide a surge protector for protecting copper wire networks from over-voltage transients having a design that provides for low capacitance/low crosstalk as well as low attenuation and low return loss.

A further advantage of the present disclosure is to provide a surge protector for protecting copper wire networks from over-voltage transients, where the surge protector includes a printed circuit board having a unique trace layout for mounting the electrical circuit components of the surge protector and for passing data signals with minimal degradation.

In a preferred embodiment of the present invention, there is provided a surge protector for protecting telecommunications related equipment and other associated sensitive electrical components from over-voltage transient occurring on tip/ring conductors of telecommunication lines coupled thereto which includes a printed circuit board and surge protection circuits being mounted on the printed circuit board. The surge protection circuits are interconnected between incoming tip and ring terminals defining an unprotected side and outgoing tip and ring terminals defining a protected side.

The printed circuit board includes first through fourth pairs of tip and ring conductive traces. Each of the surge protection circuits has a first set of steering diodes, a pair of series-connected voltage clamping devices, and a second set of steering diodes. Each of the first set of steering diodes are interconnected between a respective tip conductive trace in the first through fourth pairs of tip and ring conductive traces and a first end of the pair of series-connected voltage clamping devices. Each of the second set of steering diodes are interconnected between a respective ring conductive trace in the first through fourth pairs of tip and ring conductive traces and a second end of the pair of series-connected voltage clamping devices.

Input side connector devices are coupled to the respective incoming tip and ring terminals for connecting to incoming telecommunication lines. Output side connector devices are coupled to the respective outgoing tip and ring terminals for connecting to customers' electrical equipment to be protected.

### BRIEF DESCRIPTION OF THE SEVERAL VIEWS OF THE DRAWINGS

These and other advantages of the present disclosure will become more fully apparent from the following detailed disclosure, taken in conjunction with the accompanying sheets of drawings, wherein like numerals refer to like parts, elements, components, steps and processes, wherein:

FIG. 1 is a schematic circuit diagram of a Category 6A surge protector, constructed in accordance with the principles of the present invention;

FIG. 2 is a top plan view of a printed circuit board used for mounting the electrical circuit components of FIG. 1, showing the trace layout;

FIG. 3 is a bottom plan view of the printed circuit board of FIG. 2, showing the trace layout;

FIG. 4 is a top plan view of the printed circuit board of FIG. 1, with the electrical components mounted thereon; and

FIG. 5 is a top plan view similar to FIG. 4, illustrating the connections of the 4-pair of incoming/outgoing Ethernet cables to the respective input and output side connector devices.

### DETAILED DESCRIPTION OF THE INVENTION

It is to be distinctly understood at the outset that the present invention shown in the drawings and described in detail in conjunction with the preferred embodiments is not intended to serve as a limitation upon the scope or teachings thereof, but is to be considered merely an exemplification of the principles of the present invention.

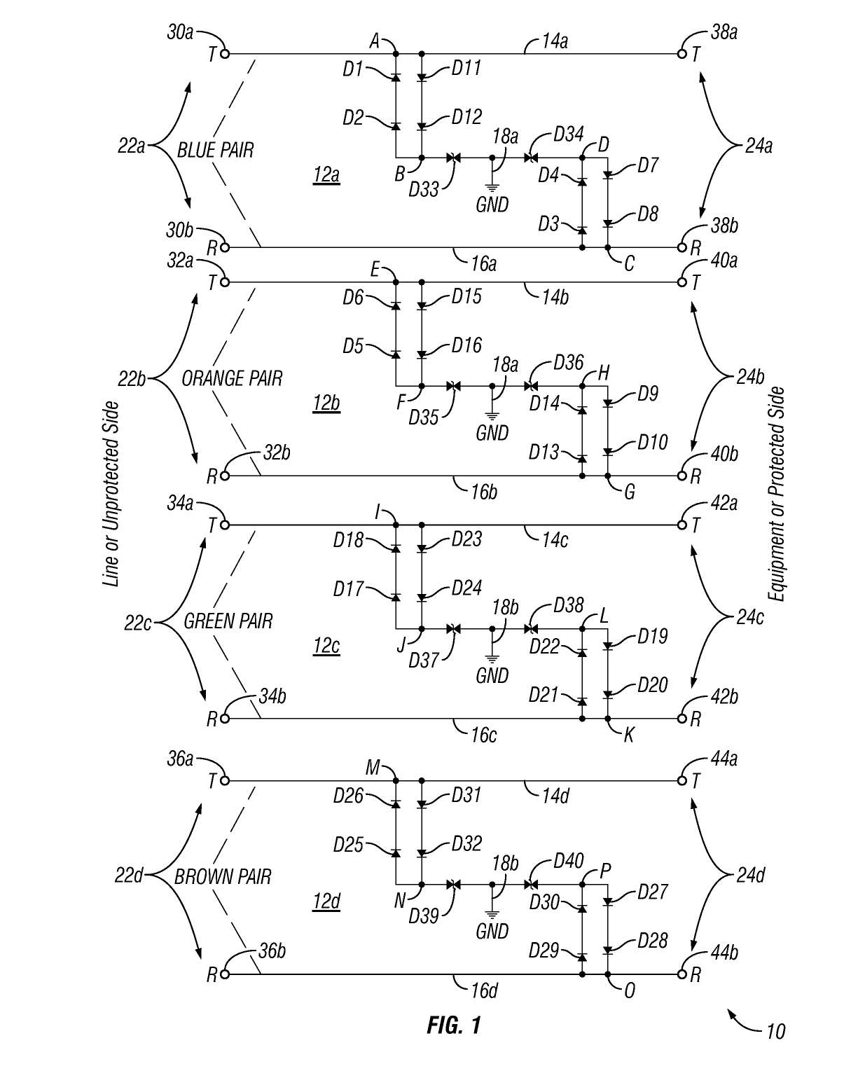

Referring now in detail to the various views of the drawings and in particular to FIGS. 1 through 4, there is illustrated a Category 6A surge protector 10 in accordance with the principles of the present invention. The Category 6A surge protector 10 has particular applications for use as a network interface for interconnection between incoming telecommunication lines carrying the voice/data signals in a signal distribution network and the different kinds of consumers' sensitive electrical equipment so as to protect the same from damage caused by transient voltage surges occurring on tip and/or conductors coupled to the telecommunication lines.

With reference specifically to FIG. 1, there is shown a detailed schematic circuit diagram of the surge protector 10 which includes a plurality of identical surge protection circuits. In the illustrated embodiment, the surge protector 10 includes four identical surge protection circuits 12a-12d. Each of the identical surge protection circuits is connectible between two wires of incoming telecommunication lines (unprotected or line side) of a signal distribution network and two wires of a customers' electrical equipment (protected or equipment side) to be protected.

For example, the surge protection circuit 12a in the illustrated embodiment includes a first set of steering diodes D1, D2, D11, D12, Transient Voltage Semiconductor (TVS) clamping devices D33, D34, and a second set of steering diodes D3, D4, D7, D8. It should be appreciated that any suitable numbers of steering diodes and voltage clamping devices may be employed. The steering diodes are high-speed, low capacitance diodes so to provide low capacitance/low crosstalk in addition to low attenuation and low return loss. As a result, the surge protector is capable of meeting the transmission performance requirements as described in the TIA Standard, TIA-568-B.2-10. The surge protector is designed to protect telecommunications related equipment against over-voltage transients while allowing transmission of a high data bit rate.

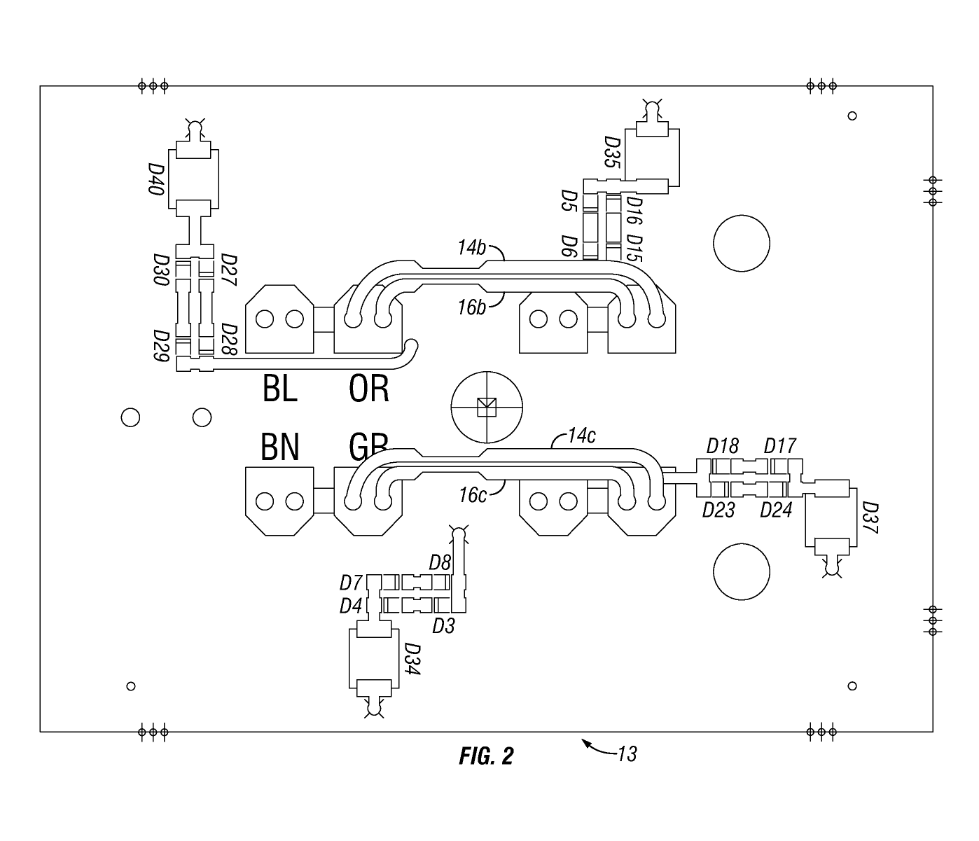

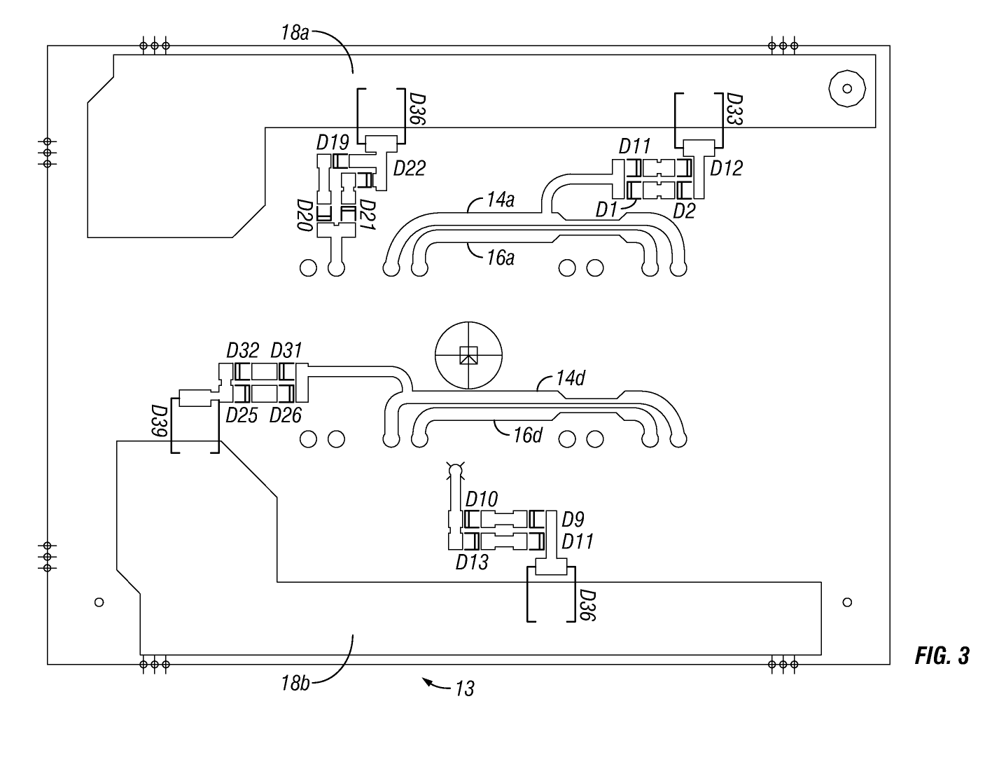

Referring now to FIG. 2, a top plan view of an exemplary printed circuit board 13 for mounting the electrical circuit components of FIG. 1 is shown. FIG. 3 shows a bottom plan view of the printed circuit board 13 of FIG. 2. As can seen, the printed circuit board 13 has a unique traced layout so as to extend the bandwidth of the present surge protector beyond the range of 500 MHz.

As can be best seen from FIGS. 1-3, the diodes D1 and D2 in the first set of steering diodes in the surge protection circuit 12a are connected together in series which are then joined in parallel to the series-connected diodes D11 and D12 in the first set. The cathode of the diode D1 and the anode of the D11 are connected together at node A and further joined to a first conductor lead. The first conductor lead in the present invention takes the physical form of a tip or first conductive trace 14a (FIG. 3). The anode of the diode D2 and the cathode of the diode D12 are connected together at node B.

The diodes D3 and D4 in the second set in the surge protection circuit 12a are connected in series which are then joined in parallel to the series-connected diodes D7 and D8 in the second set. The anode of the diode D3 and the cathode of diode D8 are connected together at node C and further joined to a second conductor lead. In the present invention, the second conductive lead takes the physical form of a ring or second conductor trace 16a (FIG. 3). The cathode of the diode D4 and the anode of the diode D7 are connected together at node D.

The first voltage clamping device D33 has its one end connected to the node B and its other end connected to a ground source GND via first ground conductor lead. In the present invention, the ground conductor lead take the physical form of enlarged, elongated common ground conductive area 18a. Similarly, the second voltage clamping device D34 has its one end connected to the node D and its other end connected to the enlarged conductive area 18a.

Similarly, the diodes D5 and D6 in the second set of steering diodes in the surge protection circuit 12b are connected together in series which are then joined in parallel to the series-connected diodes D15 and D16 in the second set. The cathode of the diode D6 and the anode of the D15 are connected together at node E and further joined to a third conductor lead. The third conductor lead in the present invention takes the physical form of a tip or third conductive trace 14b (FIG. 2). The anode of the diode D5 and the cathode of the diode D16 are connected together at node F.

The diodes D13 and D14 in the second set in the surge protection circuit 12b are connected in series which are then joined in parallel to the series-connected diodes D9 and D10 in the second set. The anode of the diode D13 and the cathode of diode D10 are connected together at node G and further joined to a fourth conductor lead. In the present invention, the fourth conductive lead takes the physical form of a ring or fourth conductor trace 16b (FIG. 2). The cathode of the diode D14 and the anode of the diode D9 are connected together at node H.

The third voltage clamping device D35 has its one end connected to the node F and its other end connected to the ground source GND via the first ground conductive area 18a. Similarly, the fourth voltage clamping device D35 has its one end connected to the node H and its other end connected to the enlarged conductive area 18a.

Further, the diodes D17 and D18 in the first set of steering diodes in the surge protection circuit 12c are connected together in series which are then joined in parallel to the series-connected diodes D25 and D24 in the first set. The cathode of the diode D16 and the anode of the D25 are connected together at node I and further joined to a fifth conductor lead. The fifth conductor lead in the present invention takes the physical form of a tip or fifth conductive trace 14c (FIG. 2). The anode of the diode D17 and the cathode of the diode D24 are connected together at node J

The diodes D21 and D22 in the second set in the surge protection circuit 12c are connected in series which are then joined in parallel to the series-connected diodes D19 and D20 in the second set. The anode of the diode D21 and the cathode of diode D20 are connected together at node K and further joined to a sixth conductor lead. In the present invention, the sixth conductive lead takes the physical form of a ring or sixth conductor trace 16c (FIG. 2). The cathode of the diode D22 and the anode of the diode D19 are connected together at node L.

The fifth voltage clamping device D37 has its one end connected to the node J and its other end connected to a ground source GND via a second ground conductor lead. In the present invention, the second ground conductor lead takes the physical form of enlarged, elongated common ground conductive area 18b. Similarly, the second voltage clamping device D38 has its one end connected to the node L and its other end connected to the enlarged conductive area 18b.

Finally, the diodes D25 and D26 in the first set of steering diodes in the surge protection circuit 12d are connected together in series which are then joined in parallel to the series-connected diodes D31 and D32 in the first set. The cathode of the diode D26 and the anode of the D31 are connected together at node M and further joined to a seventh conductor lead. The seventh conductor lead in the present invention takes the physical form of a tip or seventh conductive trace 14d (FIG. 3). The anode of the diode D25 and the cathode of the diode D32 are connected together at node N.

The diodes D29 and D30 in the second set in the surge protection circuit 12d are connected in series which are then joined in parallel to the series-connected diodes D27 and D28 in the second set. The anode of the diode D29 and the cathode of diode D28 are connected together at node O and further joined to an eighth conductor lead. In the present invention, the eighth conductive lead takes the physical form of a ring or eighth conductor trace 16d (FIG. 3). The cathode of the diode D30 and the anode of the diode D27 are connected together at node P.

The seventh voltage clamping device D39 has its one end connected to the node N and its other end connected to the second ground conductive area 18b. Similarly, the eighth voltage clamping device D40 has its one end connected to the node P and its other end connected to the enlarged conductive area 18b.

In the preferred embodiment, each of the low capacitance steering diodes D1 through D32 are similar to the type Bav 103 manufactured by Vishay. Further, the TVS clamping devices D33 through D40 are similar to the type 1.5Kexx series device also manufactured by Vishay.

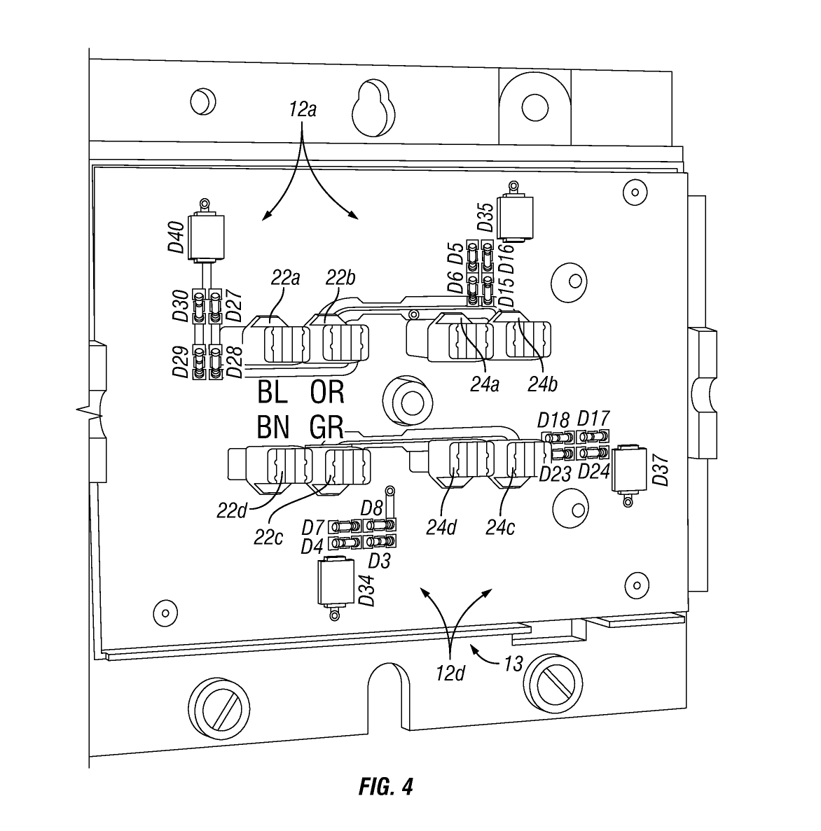

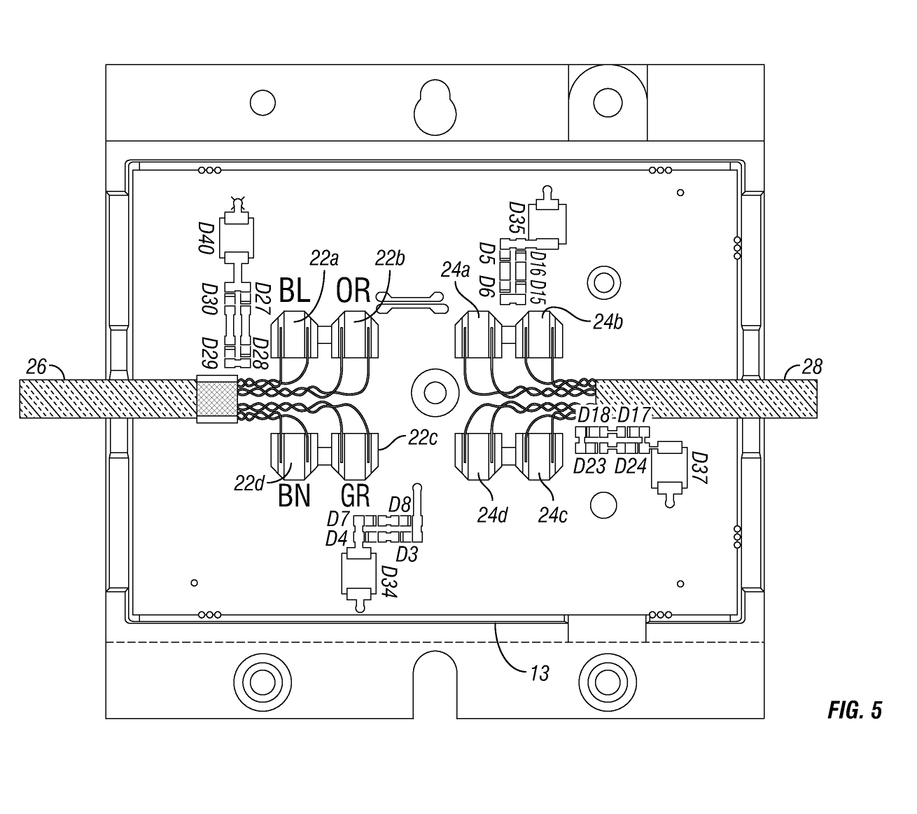

As illustrated in FIGS. 4 and 5, there is shown the exemplary printed circuit board 13 for mounting the electrical circuit components of FIG. 1. The printed circuit board 13 further includes input connector devices 22a-22d and output connector devices 24a-24d. The input and output connector devices 22a-22d and 24a-24d can be any number of commercially available connectors well known in the art. For telecommunication equipment, the input and output connector devices are preferably comprised of AT&T Category 6A 110 style terminal connectors each having a 2-position so that it can accommodate one pair of the 4-pair of incoming telecommunication lines from the signal distribution network within a building.

In FIG. 5, there is depicted an incoming Ethernet cable 26 (coupled to the signal distribution network not shown) having 4-pair of wires (8 conductors) with each pair being connected to a respective one of the input connector devices 22a-22d. A first pair of the 4-pair of wires of the cable 26 is connected across an input tip terminal 30a and an input ring terminal 30b of the connector device 22a (FIG. 1). A second pair of the 4-pair of wires of the cable 26 is connected across an input tip terminal 32a and an input ring terminal 32b of the connector device 22b. A third pair of the 4-pair of wires of the cable 26 is connected across an input tip terminal 34a and an input ring terminal 34b of the connector device 22c. A fourth pair of the 4-pair of wires of the cable 26 is connected across an input tip terminal 36a and an input ring terminal 36b of the connector device 22d.

In addition, an output Ethernet cable 28 (coupled to the customers' equipment to be protected) having 4-pair of wires with each pair is connected to a respective of the output connector devices 24a-24d. A first pair of the 4-pair of wires of the cable 28 is connected across an output tip terminal 38a and an output ring terminal 38b of the connector device 24a. (FIG. 1) A second pair of the 4-pair of wires of the cable 28 is connected across an output tip terminal 40a and an output ring terminal 40b of the connector device 24b. A third pair of the 4-pair of wires of the cable 28 is connected across an output tip terminal 42a and an output ring terminal 42b of the connector device 24c. A fourth pair of the 4-pair of wires of the cable 28 is connected across an output tip terminal 44a and an output ring terminal 44b of the connector device 24d.

The present invention relates to the unique surge protection circuits 12a-12d mounted on the printed circuit board 13 in conjunction with the layout of the tip/ring conductive traces 14a-16a through 16a-16d on the printed circuit board and the input/output connector devices 22, 24 in order to exceed the TIA Standard 568-B.2-10 for Category 6A. The fabrication technology for the tip/ring conductive traces on the printed circuit board can be best understood by reference again to FIGS. 2 and 3. Each of the pair of tip and ring conductive traces such as 14a, 16a are uniformly paired in the layout of the printed circuit board so as to produce maximum RF coupling.

Further, each paired signal traces are separated and spaced apart a predetermined distance from each other of the paired signal traces in order to eliminate crosstalk between the pairs. In addition, all of the paired traces are separated from the surge ground return 18a, 18b to prevent noise coupling. In particular, the ground returns 18a, 18b are located on the opposite side edges of the printed circuit board 13 and on the opposite side from the tip/ring conductive traces 14a, 16a through 14d, 16d. The layout has been designed to withstand the UL497 surge and to perform according to the TIA Standard, TIA-568-B.2-10.

Furthermore, low impedance ground plane and connections for maximum surge capability are used as well as CATEGORY 6A rated wire connections. In addition, it will be noted that each of tip conductive traces 14a-14d has been maintained to be in a parallel relationship with the respective ring conductive traces 16a-16d and are made to be relatively straight in order to provide low impedance and low insertion loss.

In view of the foregoing detailed description, it can be seen that the surge protector of the present invention is designed to protect networks equipment from over-voltage transients, while maintaining high bandwidth network connectivity. The present surge protector is uniquely designed so as to protect against surge levels as described in UL 497, installed in accordance with Article 800 of the National Electric Code (NEC). The instant surge protector helps to reduce the risk of fire, electrical shock, damage to equipment or injury as deployed to high-speed data systems.

While there has been illustrated and described what are at present considered to be preferred embodiments of the present invention, it will be understood by those skilled in the art that various changes and modifications may be made, and equivalents may be substituted for elements thereof without departing from the true scope of the invention. In addition, many modifications may be made to adapt a particular situation or material to the teachings of the invention without departing from the central scope thereof. Therefore, it is intended that this invention not be limited to the particular embodiments disclosed as the best modes contemplated for carrying out the invention, but that the invention will include all embodiments falling within the scope of the appended claims.

What is claimed is:

1. A surge protector for protecting telecommunications related equipment and other associated sensitive electrical components from over-voltage transient occurring on tip/ring conductors of telecommunication lines coupled thereto, comprising:
a printed circuit board;
a plurality of surge protection circuits being mounted on said printed circuit board, each one of said plurality of surge protection circuits being interconnected between incoming tip and ring terminals defining an unprotected side and outgoing tip and ring terminals defining a protected side;
said printed circuit board including first through fourth pairs of tip and ring conductive traces;
each of said plurality of surge protection circuits including a first set of steering diodes, a pair of series-connected voltage clamping devices, and a second set of steering diodes;
each of said first set of steering diodes being interconnected between a respective tip conductive trace in said first through fourth pairs of tip and ring conductive traces and a first end of said pair of series-connected voltage clamping devices;
each of said second set of steering diodes being interconnected between a respective ring conductive trace in said first through fourth pairs of tip and ring conductive traces and a second end of said pair of series-connected voltage clamping devices;
input side connector means coupled to the respective incoming tip and ring terminals for connecting to incoming telecommunication lines; and
output side connector means coupled to the respective outgoing tip and ring terminals for connecting to customers' electrical equipment to be protected.

2. A surge protector as claimed in claim 1, wherein said input side connector means includes a plurality of AT&T style 110 connector devices.

3. A surge protector as claimed in claim 2, wherein said output side connector means includes a plurality of AT&T style 110 connector devices.

4. A surge protector as claimed in claim 1, wherein each of said first set of steering diodes is formed of a high-speed, low capacitance diode.

5. A surge protector as claimed in claim 4, wherein each of said second set of steering diodes is formed of a high-speed, low capacitance diode.

6. A surge protector as claimed in claim 5, wherein each of said voltage clamping devices is formed of a Transient Voltage Semiconductor (TVS) clamping device.

7. A surge protector as claimed in claim 1, wherein each pair of said tip and ring conductive traces are spaced apart a predetermined distance from each other pair so to reduce cross-talk therebetween.

8. A surge protector as claimed in claim 7, wherein each of said tip conductive traces within each pair are maintained to be in a parallel relationship with the respective said ring conductive traces and are made relatively straight so as to provide low impedance and low insertion loss.

9. A surge protector as claimed in claim 8, further comprising grounding means are located on the opposite side edges of the printed circuit board and on the opposite side from the tip/ring conductive traces in order to prevent noise coupling.

10. A surge protector for protecting telecommunications related equipment and other associated sensitive electrical components from over-voltage transient occurring on tip/ring conductors of telecommunication lines coupled thereto, comprising:
printed circuit board means;
surge protection circuit means being mounted on said printed circuit board means, said surge protection circuit means being interconnected between incoming tip and ring terminals defining an unprotected side and outgoing tip and ring terminals defining a protected side;
said printed circuit board means including first through fourth pairs of tip and ring conductive traces;
said surge protection circuit means including a plurality of surge protection circuits each having a first set of steering diodes, a pair of series-connected voltage clamping devices, and a second set of steering diodes;
each of said first set of steering diodes being interconnected between a respective tip conductive trace in said first through fourth pairs of tip and ring conductive traces and a first end of said pair of series-connected voltage clamping devices;
each of said second set of steering diodes being interconnected between a respective ring conductive trace in said first through fourth pairs of tip and ring conductive traces and a second end of said pair of series-connected voltage clamping devices;
input side connector means coupled to the respective incoming tip and ring terminals for connecting to incoming telecommunication lines; and
output side connector means coupled to the respective outgoing tip and ring terminals for connecting to customers' electrical equipment to be protected.

11. A surge protector as claimed in claim 10, wherein said input side connector means includes a plurality of AT&T style 110 connector devices.

12. A surge protector as claimed in claim 11, wherein said output side connector means includes a plurality of AT&T style 110 connector devices.

13. A surge protector as claimed in claim 10, wherein each of said first set of steering diodes is formed of a high-speed, low capacitance diode.

14. A surge protector as claimed in claim 13, wherein each of said second set of steering diodes is formed of a high-speed, low capacitance diode.

15. A surge protector as claimed in claim 14, wherein each of said voltage clamping devices is formed of a Transient Voltage Semiconductor (TVS) clamping device.

16. A surge protector as claimed in claim 10, wherein each pair of said tip and ring conductive traces are spaced apart a predetermined distance from each other pair so to reduce cross-talk therebetween.

17. A surge protector as claimed in claim 16, wherein each of said tip conductive traces within each pair are maintained to be in a parallel relationship with the respective said ring conductive traces and are made relatively straight so as to provide low impedance and low insertion loss.

18. A surge protector for protecting telecommunications related equipment and other associated sensitive electrical components from over-voltage transient occurring on tip/ring conductors of telecommunication lines coupled thereto, comprising:
printed circuit board means;
surge protection circuit means being mounted on said printed circuit board means, said surge protection circuit means being interconnected between incoming tip and ring terminals defining an unprotected side and outgoing tip and ring terminals defining a protected side;
said printed circuit board means including first through fourth pairs of tip and ring conductive traces;
said surge protection circuit means including a plurality of surge protection circuits each having a first set of steering diodes, a pair of series-connected voltage clamping devices, and a second set of steering diodes;
each of said tip conductive traces within each pair being maintained to be in a parallel relationship with the respective said ring conductive traces and being made relatively straight so as to provide low impedance and low insertion loss.

19. A surge protector as claimed in claim 18, wherein each pair of said tip and ring conductive traces are spaced apart a predetermined distance from each other pair so to reduce cross-talk therebetween.

20. A surge protector as claimed in claim 19, wherein each of said first and second sets of steering diodes is formed of a high-speed, low capacitance diode.
